(19) United States
(12) Patent Application Publication
(10) Pub. No.: US 2007/0001083 A1
(43) Pub. Date: Jan. 4, 2007

(54) Mounting apparatus for a mobile communication device

(76) Inventors: Daniel Martin, Hialeah, FL (US); Peter B. Gilmore, Plantation, FL (US); David H. McClintock, Davie, FL (US); Benamanahalli K. Nagaraj, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/171,605

(22) Filed: Jun. 30, 2005

(51) Int. Cl. F16M 7/00; F16M 1/00; F16M 3/00; F16M 5/00; F16M 11/00; F16M 9/00

(52) U.S. Cl. 248/674

(57) ABSTRACT

A mounting apparatus (100) for a mobile communication device includes a unitarily formed bracket (102) having side surfaces (104) with integrated lock washer functionality. Cantilevered beams (106, 108) are deflected outward from the side surfaces (104) forming a clearance (110) through which to receive a screw (210) for coupling the mobile communication device (302) to the bracket (102). The cantilevered beams (106, 108) minimize backward rotation of the screw (210) and provide compliancy between the bracket (102), the screw (210) and the mobile communication device (302).

### CROSS-REFERENCED TO OTHER APPLICATION(S)

This application is cross-referenced to patent application entitled MOUNTING APPARATUS FOR A MOBILE COMMUNICATION DEVICE, Attorney Docket No. CM08457K, filed on even date herewith.

### TECHNICAL FIELD

This invention relates in general to mobile communication devices and more particularly to mounting mechanisms for such devices.

### BACKGROUND

Mobile communication devices, particularly high power data and radio devices, require strong, stable mechanisms for mounting these devices into vehicles. In operation, mobile communication devices are regularly subjected to vibration, shock and various other adverse conditions. A bracket is typically mounted to the vehicle and used to retain the mobile communication device with mounting screws. During vibration and mechanical shock exposure, it is not uncommon to experience structural failure events such as loosening and/or shearing of mounting screws. When such assemblies are subjected to vibration or dynamic loading, the screws tend to loosen and eventually shear. Both a lack of proper preloading of the screws and a lack of compliancy in the system can cause such failures.

In many mobile communication systems, lock washers are used to prevent screws from loosening away from the bracket. However, the use of separate washer elements increases parts count, installation time and complexity. Some mounting bracket designs have eliminated the use of lock washers, but currently available designs still face issues with loosening of the screws during vibration and mechanical shock exposure.

Accordingly, there is a need for an improved mounting apparatus for a mobile communication device.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a mounting apparatus in accordance with an embodiment of the invention;

FIG. 2 is an embodiment incorporating the mounting apparatus of FIG. 1; and

FIG. 3 is a communication system in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and shall not be limited by the embodiments shown below. It is further understood that the use of relational terms, if any, such as first, second, top and bottom, front and rear and the like are used solely for distinguishing one entity or action from another, without necessarily requiring or implying any such actual relationship or order between such entities or actions.

Briefly, there is provided herein an apparatus for mounting a mobile communication device, such as to a vehicle. The mounting apparatus includes cantilevered beams to provide compliancy features and integrated lock washer functionality to the screw area of a mounting bracket. The compliancy features absorb vibration and shock while the integrated lock washer functionality minimizes backward screw rotation thereby preventing the mounting screws from loosening or backing off from the mounting bracket.

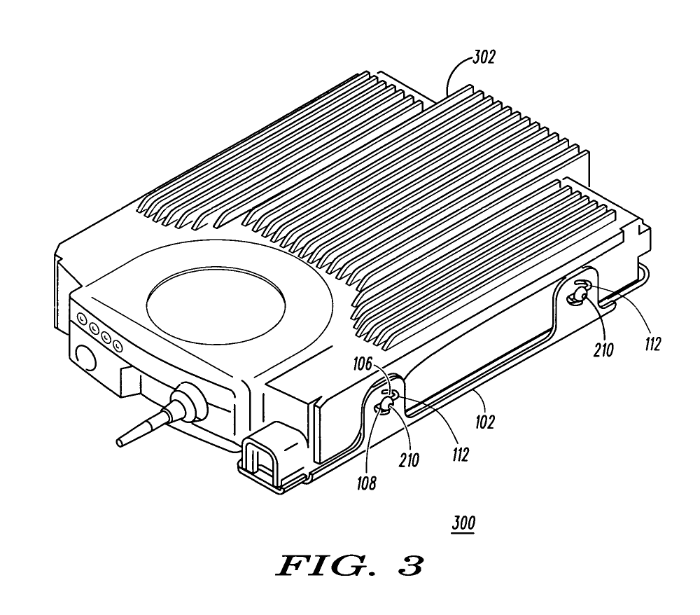

FIG. 1 shows a mounting apparatus for a mobile communication device formed in accordance with the present invention. Mounting apparatus 100 includes a bracket 102 having a surface 104 including first and second cantilevered beams 106, 108, preferably curved in shape, deflecting outward from the surface. The first and second cantilevered beams 106, 108 form a clearance 110 through which to receive a screw for coupling a mobile communication device to the bracket 102 (shown in FIG. 3). The use of deflected cantilevered beams 106, 108 provides compliancy between a screw (shown later) and the bracket 102 as well as compliancy between the mobile communication device and the bracket.

In accordance with the present invention, surface 104 includes a cut-away portion 112 characterized by a geometry that minimizes counterclockwise rotation of the screw. The preferred geometry utilizes an inverted s-shape cut-away having a clearance hole 110 for receiving the screw located between the curved cantilevered beams 106, 108.

In accordance with the present invention, the first and second cantilevered beams 106, 108 provide compliant coupling of the mobile communication device to the bracket. The curvature of the cantilevered beams in conjunction with the cut-away provide integrated lock washer functionality to prevent the screw from backing off. The amount of beam deflection can be adjusted from one product line to another based on product design requirements.

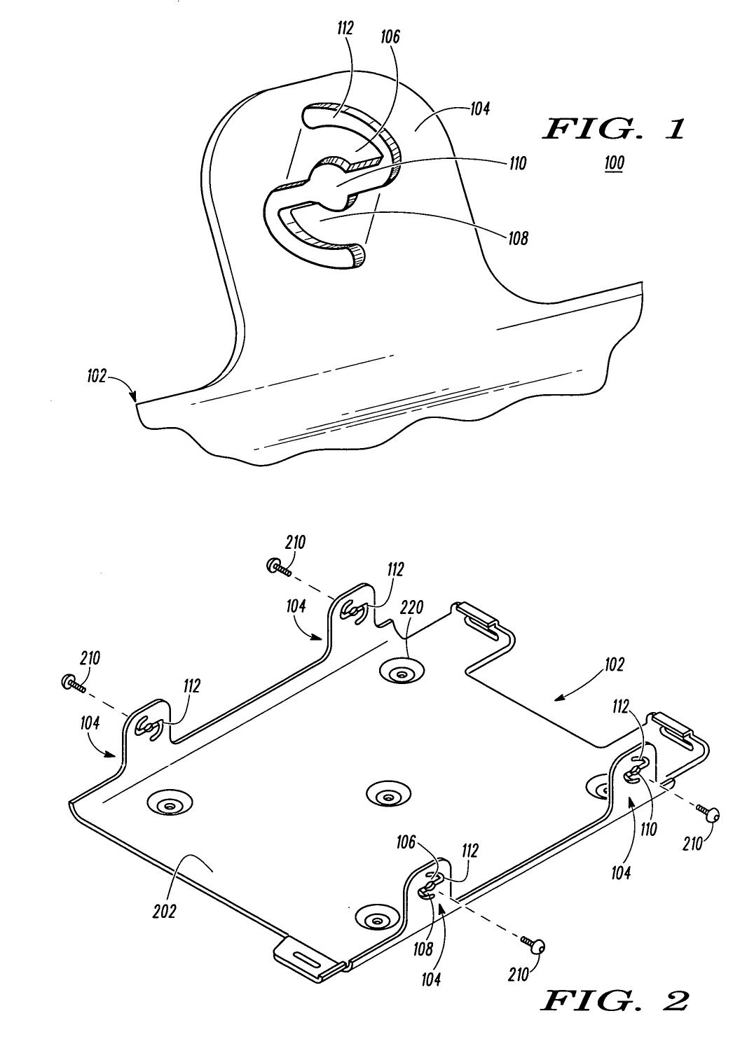

Referring to FIG. 2, there is shown a mounting apparatus for a mobile communication device including a plurality of side panel surfaces formed in accordance with the embodiment of FIG. 1. In this view, bracket 102 is shown with bottom surface 202 and four side surfaces 104 extending therefrom in the form of tabs or side panels. The bracket 102 is a unitarily formed piece of metal. The bottom surface 202 of bracket 102 includes througholes 220 for affixing the bracket to a vehicle.

In accordance with the present invention, each of the side surfaces 104 includes cut-away portion 112 forming a plurality of cantilevered beams 106, 108 deflecting away from each side surface and providing a clearance 110 for screw access 210. Each clearance hole 110 accepts a screw 210 which gets rotated into an opening within the mobile communication device.

FIG. 3 shows a communication system 300 including a mobile communication device 302 mounted into the mounting bracket 102 formed in accordance with the embodiment of FIG. 2. As seen in this view, screws 210 are inserted into clearance holes 110. In accordance with the present invention, the compliancy provided by the deflected cantilevered beams 106, 108 allows communication system 300 to withstand vibration and shock conditions experienced in a vehicular environment. In accordance with the present invention, the curvature of the cantilevered beams 106, 108 and cut-away portion 112 minimize backward rotation of the screws 210.

Accordingly, there has been a mounting apparatus for a mobile communication device that provides both compliancy and integrated lock washer functionality. The compliancy feature minimizes mechanical stresses thereby minimizing the potential of stripping and/or shearing of the screw while the integrated lock washer functionality prevents the screws from being loosened and backing off. By forming the bracket as a unitary piece part the need for separate washers is eliminated thus decreasing parts count, simplifying assembly complexity and assembly time.

While the embodiments shown provide for inverted s-shape geometry, other geometries may also be suitable. For applications where screws are inserted using a counter-clockwise rotation, an s-shape cut-away can be used to minimize the screws from backing off in a clockwise direction—basically the reverse of what has been described thus far. For the purposes of this application, backward rotation is any rotational direction which loosens the screw away from the bracket whether that be clockwise or counterclockwise rotation. Thus, the use of integrated cantilevered beams deflecting outward from the bracket minimize backward rotation and any backing off of the screw in a washerless system. Since lock washer functionality is integrated in the geometry of the bracket, the screws cannot become loose. A washerless system is thus provided making it easy to install and remove the mobile communication device to and from the bracket with fewer piece parts.

While the preferred embodiments of the invention have been illustrated and described, it will be clear that the invention is not so limited. Numerous modifications, changes, variations, substitutions and equivalents will occur to-those skilled in the art without departing from the spirit and scope of the present invention as defined by the appended claims.

What is claimed is:

1. A mounting apparatus for a mobile communication device, including:
a bracket having a surface including first and second cantilevered beams deflecting outward from the surface, the first and second cantilevered beams forming a clearance through which to receive a screw for coupling the mobile communication device to the bracket.

2. The mounting apparatus of claim 1, wherein the first and second cantilevered beams provide compliant coupling of the mobile communication device to the bracket.

3. The mounting apparatus of claim 1, wherein first and second cantilevered beams are curved and the first and second surfaces are cut so as to form an inverted s-shaped aperture in conjunction with the first and second cantilevered beams.

4. A mounting apparatus for a mobile communication device, including:
a bracket having a bottom surface and a plurality of side surfaces extending therefrom, each of the side surfaces having a cut-away portion forming a plurality of cantilevered beams deflecting from the side surfaces to provide screw access and compliancy between the mounting apparatus and the mobile communication device

5. The mounting apparatus of claim 4, wherein the cut-away portion is characterized by a geometry that minimizes counterclockwise rotation of the screw.

6. The mounting apparatus of claim 4, wherein the cut-away portion is characterized by a geometry that minimizes clockwise rotation of the screw.

7. The mounting apparatus of claim 4, wherein the cantilevered beams are curved cantilevered beams.

8. The mounting apparatus of claim 5, wherein the cutaway portion is an inverted s-shape with a clearance hole for receiving the screw.

9. The mounting apparatus of claim 6, wherein the cutaway portion is an s-shape with a clearance hole for receiving the screw.

10. The mounting apparatus of claim 4, wherein the cut-away portion operates as an integrated lock washer.

11. A communication system, comprising:
a mobile communication device; and
a unitarily formed mounting bracket including curved cantilevered beams integrated therein and deflecting outward from the bracket, the mobile communication device being retained within the mounting bracket via screws applied to the curved cantilevered beams.

12. The communication system of claim 11, wherein the curved cantilevered beams minimize backward rotation of the screws.

13. The communication system of claim 12, wherein the deflection of the curved cantilevered beams provides compliancy to the communication system.

14. The communication system of claim 13, wherein the system is washerless.
